(19) United States
(12) Patent Application Publication
(10) Pub. No.: US 2018/0367196 A1
(43) Pub. Date: Dec. 20, 2018

(54) EFFICIENT TECHNIQUES TO SIGNAL CODEBOOK SUBSET RESTRICTION BIT MAP IN WIRELESS COMMUNICATION SYSTEMS

(71) Applicant: Telefonaktiebolaget LM Ericsson (publ), Stockholm (SE)

(72) Inventors: Sairamesh Nammi, Austin, TX (US); Namir Lidian, Solna (SE)

(21) Appl. No.: 15/770,989

(22) PCT Filed: Nov. 24, 2016
(86) PCT No.: PCT/SE2016/051162

§ 371 Date: Apr. 25, 2018

Related U.S. Application Data
(60) Provisional application No. 62/262,208, filed on Dec. 2, 2015.

(51) Int. Cl. H04B 7/0456; H04L 25/03; H04B 7/06

(52) U.S. Cl. CPC H04B 7/0473; H04L 25/03929; H04W 76/27; H04B 7/0486; H04B 7/0639

(57) ABSTRACT

Efficient techniques to signal codebook subset restriction bit maps are provided. In some embodiments, a method of operation of a node of a cellular communications network includes determining a codebook restriction for a wireless device. The codebook restriction reduces a full codebook of the wireless device to a reduced codebook. The method also includes providing the codebook restriction to the wireless device with an indication of one or more ranks to which the codebook restriction applies. In some embodiments, this enables reduced signaling overhead from upper layers, improving the throughput of data traffic channels. This may also enable reduced RRC signaling message failures and also reduced latency.

### RELATED APPLICATIONS

This application claims the benefit of provisional patent application Ser. No. 62/262,208, filed Dec. 2, 2015, the disclosure of which is hereby incorporated herein by reference in its entirety.

### TECHNICAL FIELD

This disclosure is related to wireless communications systems and in particular conveying a codebook subset restriction bit map to a receiving terminal.

### BACKGROUND

3^{rd} Generation Partnership Project (3GPP) Long Term Evolution (LTE) represents the project within the 3GPP with an aim to improve the Universal Mobile Telecommunications Service (UMTS) standard. A 3GPP LTE radio interface offers high peak data rates, low delays, and an increase in spectral efficiencies. The LTE ecosystem supports both Frequency Division Duplex (FDD) and Time Division Duplex (TDD). This enables the operators to exploit both the paired and unpaired spectrums since LTE has flexibility in bandwidth, as it supports six bandwidths: 1.4 megahertz (MHz), 3 MHz, 5 MHz, 10 MHz, 15 MHz, and 20 MHz.

The LTE physical layer is designed to achieve higher data rates and is facilitated by turbo coding/decoding and higher order modulations (up to 256 Quadrature Amplitude Modulation (QAM)). The modulation and coding is adaptive and depends on channel conditions. Orthogonal Frequency Division Multiple Access (OFDMA) is used for the downlink, while Single Carrier Frequency Division Multiple Access (SC-FDMA) is used for the uplink. The main advantage of such schemes is that the channel response is flat over a subcarrier even though the multi-path environment could be frequency selective over the entire bandwidth. This reduces the complexity involved in equalization, as simple single tap frequency domain equalizers can be used at the receiver. OFDMA allows LTE to achieve its goal of higher data rates, reduced latency, and improved capacity/coverage with reduced costs to the operator. The LTE physical layer supports Hybrid Automatic Repeat Request (HARQ), power weighting of physical resources, uplink power control, and Multiple Input Multiple Output (MIMO). By using multiple parallel data streams' transmissions to a single terminal, data rate can be increased significantly.

In a multi-path environment, such a multiple access scheme also provides opportunities for performance enhancing scheduling strategies. Frequency Selective Scheduling (FSS) can be used to schedule a user over subcarriers (or part of the bandwidth) that provide maximum channel gains to that user (and avoid regions of low channel gain). The channel response is measured, and the scheduler utilizes this information to intelligently assign resources to users over parts of the bandwidth that maximize their signal-to-noise ratios (and spectral efficiency). In other words, the end to end performance of a multi-carrier system like LTE relies significantly on subcarrier allocation techniques and transmission modes. LTE allows for different opportunistic scheduling techniques; a source of significant product differentiation between competing companies.

FIG. 1 illustrates one example of a cellular communications network 10. In this example, the cellular communications network 10 is a 3GPP LTE network; however, the present disclosure is not limited thereto. As illustrated, the cellular communications network 10 includes a Radio Access Network (RAN), which in this example is an Enhanced or Evolved Universal Terrestrial RAN (E-UTRAN) 12. The E-UTRAN 12 includes a number of base stations, which in 3GPP terminology are referred to as eNBs 14, that serve corresponding cells 16. The eNBs 14 provide radio access to wireless devices, which in 3GPP terminology are referred to as UEs 18, located in the respective cells 16. The eNBs 14 communicate via a base-station-to-base-station interface, which in 3GPP LTE is referred to as an X2 interface. The eNBs 14 are also connected to a core network, which in 3GPP LTE is referred to as an Evolved Packet Core (EPC) 20, via S1 interfaces.

The EPC 20 includes various core network nodes including, for example, one or more Mobility Management Entities (MMEs) 22, one or more Serving Gateways (S-GWs) 24, one or more Packet Data Network (PDN) Gateways (P-GWs) 26, one or more Home Subscriber Servers (HSSs) 28, one or more Service Capability Exposure Function (SCEFs) 30, one or more Interworking SCEFs (IWK-SCEFs) 32, and one or more Service Capability Servers (SCSs)/Application Servers (ASs) 34.

MIMO is an advanced antenna technique to improve spectral efficiency and thereby boost overall system capacity. The MIMO technique uses a commonly known notation (M×N) to represent MIMO configuration in terms of the number of transmit (M) and receive antennas (N). The common MIMO configurations used or currently standardized for various technologies are: (2×1), (1×2), (2×2), (4×2), (4×4), (8×2), (8×4), and (8×8). The configurations represented by (2×1) and (1×2) are special cases of MIMO, and they correspond to transmit diversity and receiver diversity, respectively. Current LTE (up to Release 12) supports the use of a one dimensional array of co- or cross-polarized antenna ports. Under development for Release 13 is standard support for two dimensional antenna ports, where antenna ports are located in both vertical and horizontal dimensions.

Multiple antennas employed at the transmitter and receiver can significantly increase the system capacity. By transmitting independent symbol streams in the same frequency bandwidth, usually termed as Spatial Multiplexing (SM), it is possible to achieve a linear increase in data rates with the increased number of antennas. On the other hand, by using space-time codes at the transmitter, reliability of the detected symbols can be improved by exploiting the so-called transmit diversity. Both these schemes assume no channel knowledge at the transmitter. However, in practical wireless systems such as 3GPP LTE, High Speed Downlink Packet Access (HSDPA), and Worldwide Interoperability for Microwave Access (WiMAX) systems, the channel knowledge can be made available at the transmitter via feedback from the receiver to the transmitter. The MIMO transmitter can utilize this channel information to improve the system performance with the aid of precoding. In addition to beam forming gain, the use of precoding avoids the problem of ill-conditioned channel matrix.

In practice, complete Channel State Information (CSI) may be available for a communication system using the TDD scheme by exploiting channel reciprocity. However, for a FDD system, complete CSI is more difficult to obtain. In a FDD system, some kind of CSI knowledge may be available at the transmitter via feedback from the receiver. These systems are called limited feedback systems. There are many implementations of limited feedback systems, such as codebook based feedback and quantized channel feedback. 3GPP LTE, HSDPA, and WiMax recommend codebook based feedback CSI for precoding. Examples of CSI are Channel Quality Indicator (COI), Precoding Index (PCI), Precoding Matrix Indicator (PMI), and Rank Indicator (RI). One or a combination of different types of CSI is used by the network node (e.g., a Node B in Universal Terrestrial Radio Access (UTRA) or an enhanced or evolved Node B (eNB) B in LTE) for one or more resource assignment related tasks such as scheduling data to a User Equipment device (UE), rank adaptation of MIMO streams, precoder selection for MIMO streams, etc.

In codebook based precoding, a predefined codebook is defined both at the transmitter and the receiver. The entries of the codebook can be constructed using different methods. For example, Grassmannian, Lloyd algorithm, Discrete Fourier Transform (DFT) matrix, etc. The precoder matrix is often chosen to match the characteristics of the N_{R}×N_{T} MIMO channel matrix H, resulting in so-called channel dependent precoding. This is also commonly referred to as closed-loop precoding and essentially strives for focusing the transmit energy into a subspace which is strong in the sense of conveying much of the transmitted energy to the UE. In addition, the precoder matrix may also be selected to strive for orthogonalizing the channel, meaning that after proper linear equalization at the UE, the inter-layer interference is reduced. At the receiver it is common to find the Signal to Interference plus Noise Ratio (SINR) with different codebook entries and choose the RI/PCI which gives highest spectral efficiency (capacity).

However, the network can choose only a small number of precoding elements for a variety of reasons and indicate this to the UE. This is called codebook subset restriction or also called precoding weight restriction.

According to 3GPP standard TS 36.213, a UE is restricted to report PMI and RI within a precoder codebook subset specified by a bitmap parameter codebookSubsetRestriction configured by higher layer signaling. For a specific precoder codebook and associated transmission mode, the bitmap can specify all possible precoder codebook subsets the UE can assume the eNB may be using when the UE is configured in the relevant transmission mode. Codebook subset restriction is supported for open-loop spatial multiplexing, closed-loop spatial multiplexing, multi-user MIMO and closed-loop Rank=1 precoding. The resulting number of bits for each transmission mode is given in Table 1. The bitmap forms the bit sequence a_{A}_{_{c}}₋₁, . . . , a₃, a₂, a₁, a₀ where a₀ is the Least Significant Bit (LSB) and a_{A}_{_{c}}₋₁ is the Most Significant Bit (MSB) and where a bit value of zero indicates that the PMI and RI reporting is not allowed to correspond to a precoder(s) associated with the bit. The associations of bits to precoders for the relevant transmission modes are given as follows:

TABLE 1
Number of bits in codebook subset restriction
bitmap for applicable transmission modes.

| | | Number of bits A_{c} | | |
|---|---|---|---|---|
| | | 2 | 4 | 8 |
| | | antenna | antenna | antenna |
| | | ports | ports | ports |
| Transmission | Open-loop spatial | 2 | 4 | — |
| Mode | multiplexing (TM3) | | | |
| | Closed-loop spatial | 6 | 64 | — |
| | multiplexing (TM4) | | | |
| | Multi-User MIMO | 4 | 16 | — |
| | (TM5) | | | |
| | Closed-loop rank = 1 | 4 | 16 | — |
| | precoding (TM6) | | | |
| | Closed-loop spatial | 6 | 96 | 109 |
| | multiplexing with | | | |
| | CSI-RS and DM-RS | | | |
| | (TM9 and TM10) | | | |

There are many applications of codebook subset restriction; for example, to reduce the computational complexity at the UE side during a PMI/RI search from the network, etc. In this case, the network needs to send Radio Resource Control (RRC) reconfiguration messages with different bit maps.

Active Array Antenna Systems (AAS), where Radio Frequency (RF) components such as power amplifiers and transceivers are integrated with an array of antennas elements, as shown in FIG. 2, offer several benefits compared to traditional deployments with passive antennas connected to transceivers through feeder cables. A baseband processor 28 produces a signal which is amplified by power amplifiers 30-1 through 30-N and connected to antennas 32-1 through 32-N.

FIG. 3 shows an example of a passive antenna array system that could be a part of node 14 where the signals from the baseband processor 28 are boosted by power amplifiers 34-1 through 34-N and connected to the antennas 32-1 through 32-N by longer feeder cables through a power combiner/divider and phase shifter 36. By using an active antenna array, not only are cable losses reduced, leading to improved performance and reduced energy consumption, but the installation is simplified and the required equipment space is reduced.

There are many applications of active antennas; for example, cell specific beamforming, user specific beamforming, vertical sectorization, massive MIMO, elevation beamforming, etc. Active antennas could also potentially be used as enablers for further-advanced antenna concepts, such as deploying a large number of MIMO antenna elements at the eNode B. For these reasons, 3GPP began investigating the feasibility of increasing the number of transmit antennas to 16/32/64 for various purposes and extending the CSI feedback to support 2-dimensional antenna arrays where up to 64 eNode B antenna ports are distributed both in vertical and horizontal directions.

FIG. 4 shows a 2D antenna system according to some embodiments. Again, this could be part of a node 14. The individual antenna elements are grouped to make antennas 32-1 through 32-N. The received signal for the i^{th} subcarrier can be written as:

Y=HWx+n

where H is the 3 dimensional channel matrix between the transmitter antenna elements dimensions (Nr×Nh×Nv), W is the 3 dimensional precoding matrix of dimensions (Nh×Nv×R), and x is the transmitted signal vector of size (R×1), where Nr is the number of receiver antennas, Nh is the number of transmit antennas in the horizontal direction, Nv is the number of antenna elements in vertical direction per each horizontal branch, and R is the transmission rank of the system. For elevation beamforming, R=1 (since rank=1).

The 3 dimensional precoding matrix can be written as:

W=Kron(Wh,Wv)=Wh⊗Wv

where, Wh is the horizontal PMI, Wv is the vertical PMI, and Kron represents the Kronecker tensor product. Hence it can be seen that the UE needs to send PMIs in two directions, one horizontally and another vertically in its CSI reporting. Therefore, there is a significant overhead in the uplink direction.

It can be observed that the UE needs to send two PMIs in its CSI report for the system to operate for elevation beamforming. One PMI is sent in the azimuth direction and the other in elevation direction.

In codebook subset restriction, the network needs to send the bitmap to the UE as in Table 1 via RRC signaling (higher layer). As shown by Table 1, the codebook size, and therefore the bitmap size, increases as the number of transmit antennas increases. For example, when the number of transmit antennas is increased to 64, the bitmap size becomes huge. This implies that a lot of signaling overhead (through higher layer signaling) needs to be conveyed to the UE whenever the network needs to configure/reconfigure the UE with codebook subset restriction. Hence efficient techniques are needed to convey the bitmap to the UE without causing much overhead.

### SUMMARY

Efficient techniques to signal codebook subset restriction bit maps are provided. In some embodiments, a method of operation of a node of a cellular communications network includes determining a codebook restriction for a wireless device. The codebook restriction reduces a full codebook of the wireless device to a reduced codebook. The full codebook comprises precoding matrices for a plurality of ranks. The method also includes providing the codebook restriction to the wireless device with an indication of one or more ranks to which the codebook restriction applies. This enables reduced signaling overhead from upper layers, improving the throughput of data traffic channels, according to some embodiments. This may also enable reduced Radio Resource Control (RRC) signaling message failures and also reduced latency.

In some embodiments, a method of operation of a wireless device of a cellular communications network includes receiving a codebook restriction with reduced overhead compared to receiving a full codebook subset restriction bit map, the codebook restriction being a restriction that reduces a full codebook of the wireless device (18) to a reduced codebook. The method also includes transmitting channel feedback to a node of the cellular communications network based on the codebook restriction.

In some embodiments, providing the codebook includes providing an initial RRC configuration with reduced overhead compared to providing the full codebook subset restriction bit map.

In some embodiments, providing the codebook restriction includes providing an RRC re-configuration with reduced overhead compared to providing the full codebook subset restriction bit map.

In some embodiments, providing the codebook restriction includes providing the codebook restriction to the wireless device by using physical layer signaling with reduced overhead compared to providing the full codebook subset restriction bit map.

In some embodiments, providing the codebook restriction to the wireless device includes providing an indication of which ranks the codebook restriction is applicable to. In some embodiments, the codebook restriction includes codebook restrictions for a subset of all possible ranks. The subset has fewer than all possible ranks. Providing the codebook restriction includes providing an indication of the subset of all possible ranks to which the codebook restrictions apply.

In some embodiments, the codebook restriction is for a two-dimensional antenna system. In some embodiments, providing the codebook restriction includes providing the codebook restriction for a first direction in the two-dimensional antenna system. In some embodiments, the first direction is a vertical direction. In some embodiments, the first direction is a horizontal direction.

In some embodiments, providing the codebook restriction includes providing the codebook restriction for a first direction and a second direction in the two-dimensional antenna system. In some embodiments, the first direction is a horizontal direction and the second direction is a vertical direction.

In some embodiments, the cellular communications network is an LTE network. In some embodiments, the cellular communications network is a 5G network. In some embodiments, the node is an eNB.

The present disclosure relates to methods at the network node to signal a codebook subset restriction bit map to a UE such that the overall signaling overhead is reduced.

The following advantages are achieved:
Reduced signaling overhead from upper layers thereby improving the throughput of data traffic channels due to the reduced overhead for the RRC signaling
Reduced RRC signaling message failures and also reduced latency

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications network;

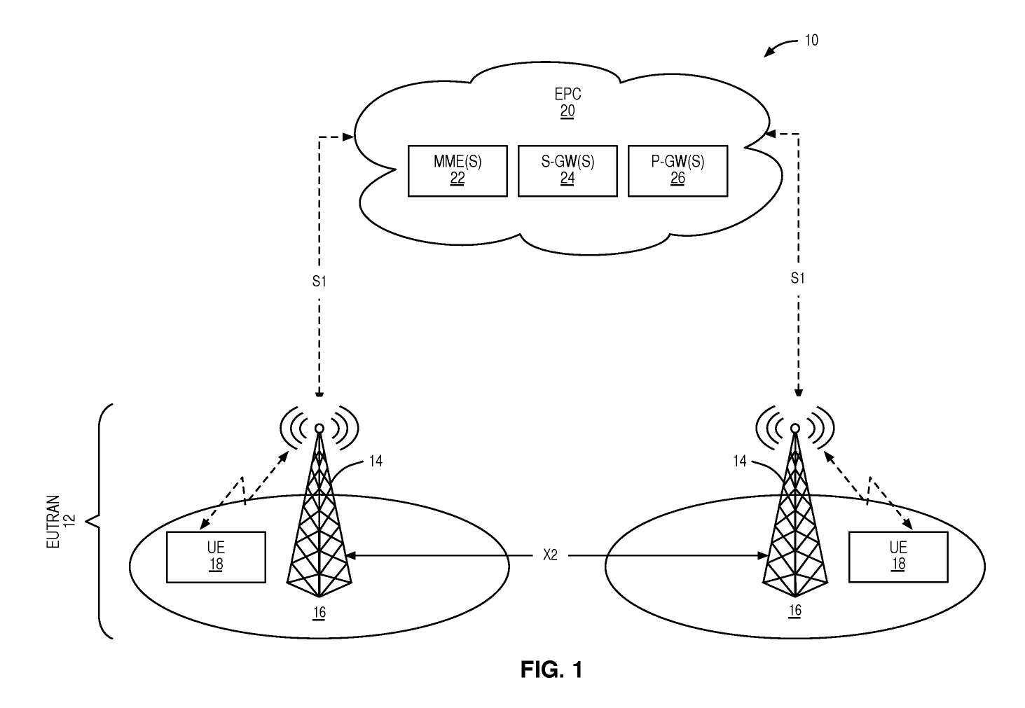

FIGS. 2 and 3 illustrate example transmitters with multiple transmit antennas, according to some embodiments of the current disclosure;

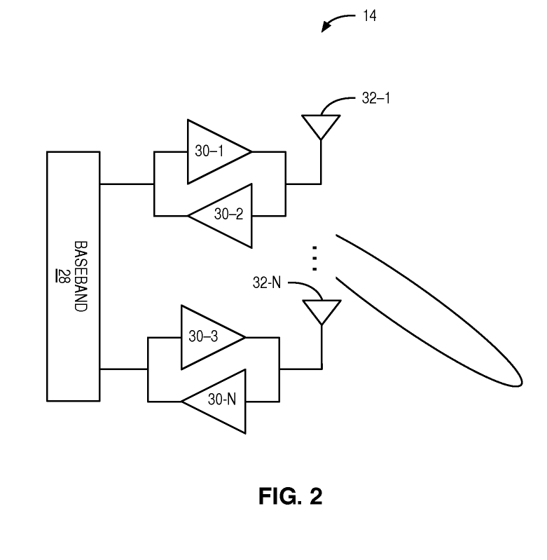

FIG. 4 illustrates an example transmitter with a two-dimensional array of antennas, according to some embodiments of the current disclosure;

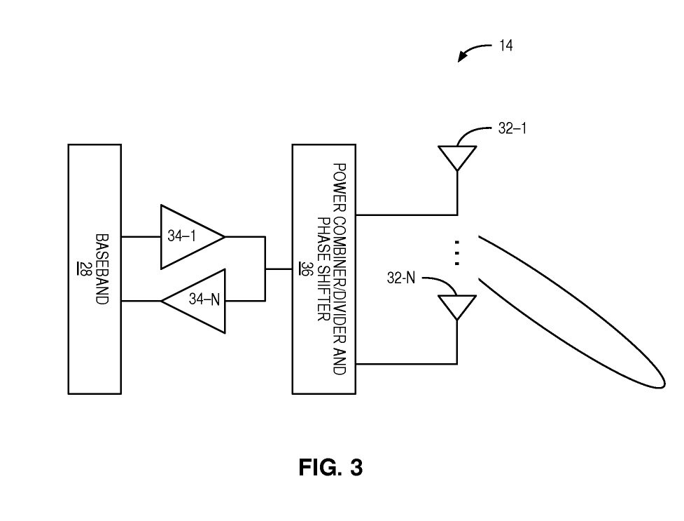

FIG. 5 illustrates a method of operating a node to provide a codebook subset restriction bit map to a wireless device, according to some embodiments of the current disclosure;

FIG. 6 illustrates a codebook subset restriction bit map based on maximum rank;

FIGS. 7A through 7C illustrate a codebook subset restriction bit map with an applied rank indicator, according to some embodiments of the current disclosure;

FIGS. 8 through 10 illustrate a way to communicate a codebook subset restriction bit map and/or an update to the codebook subset restriction bit map, according to some embodiments of the current disclosure;

FIG. 11 is a block diagram of a User Equipment device (UE) according to some embodiments of the present disclosure;

FIG. 12 is a block diagram of a UE according to some other embodiments of the present disclosure;

FIG. 13 is a block diagram of a network node according to some embodiments of the present disclosure; and

FIG. 14 is a block diagram of a network node according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

In some embodiments, the non-limiting term “radio network node” or simply “network node” is used, and it refers to any type of network node serving a User Equipment (UE) and/or connected to another network node or network element or any radio node from which the UE receives a signal. Examples of radio network nodes are Node Bs, base stations (BS), multi-standard radio (MSR) nodes such as MSR BS, eNode Bs, network controllers, Radio Network Controllers (RNC), Base Station Controllers (BSC), relays, donor node controlling relays, Base Transceiver Stations (BTS), Access Points (AP), transmission points, transmission nodes, Radio Remote Units (RRU), Radio Remote Heads (RRH), nodes in Distributed Antenna Systems (DAS), etc.

In some embodiments, the non-limiting term UE is used, and it refers to any type of wireless device communicating with a radio network node in a cellular or mobile communication system. Examples of UE are target devices, Device to Device (D2D) UEs, machine type UEs or UEs capable of Machine to Machine (M2M) communication, PDAs, iPADs, tablets, mobile terminals, smart phones, Laptop Embedded Equipment (LEE), Laptop Mounted Equipment (LME), Universal Serial Bus (USB) dongles, etc. Note that as examples, 4 Tx, 8 Tx, or 16 Tx are considered. However, this invention is equally applicable for any Nₜ Tx systems.

The embodiments are described in particular for Multiple Input Multiple Output (MIMO)/Full Dimension (FD)-MIMO operation of Evolved Universal Terrestrial Radio Access (E-UTRA)/Long Term Evolution (LTE)/LTE Advanced (LTE-A), UTRA/High Speed Packet Access (HSPA) FDD systems. The embodiments are, however, applicable to any Radio Access Technology (RAT) or multi-RAT system where the UE operates using MIMO e.g., LTE TDD, Global System for Mobile Communications (GSM)/GSM Enhanced Data for GSM Evolution (EDGE) Radio Access Network (GERAN), Wi Fi, Wireless Local Area Network (WLAN), Worldwide Interoperability for Microwave Access (WiMax), Code Division Multiple Access (CDMA)2000, LTE-NX, Massive MIMO system, etc.

The embodiments are applicable to single carrier as well as to multi-carrier (MC) or Carrier Aggregation (CA) operation of the UE in conjunction with MIMO in which the UE is able to receive and/or transmit data to more than one serving cell using MIMO. CA is also referred to as (i.e. interchangeably called) “multi-carrier system,” “multi-cell operation,” “multi-carrier operation,” or “multi-carrier” transmission and/or reception. Note that in the present disclosure the techniques are explained using a 4 carrier system; however, the techniques are not limited thereto and can be applied to any number of carrier systems. For example, the disclosed techniques may be applied to as many as 32 carriers, as in Release 13 LTE/LTE-A.

Herein, wireless transmissions in the downlink are discussed, but the presently disclosed technology is equally applicable in the uplink.

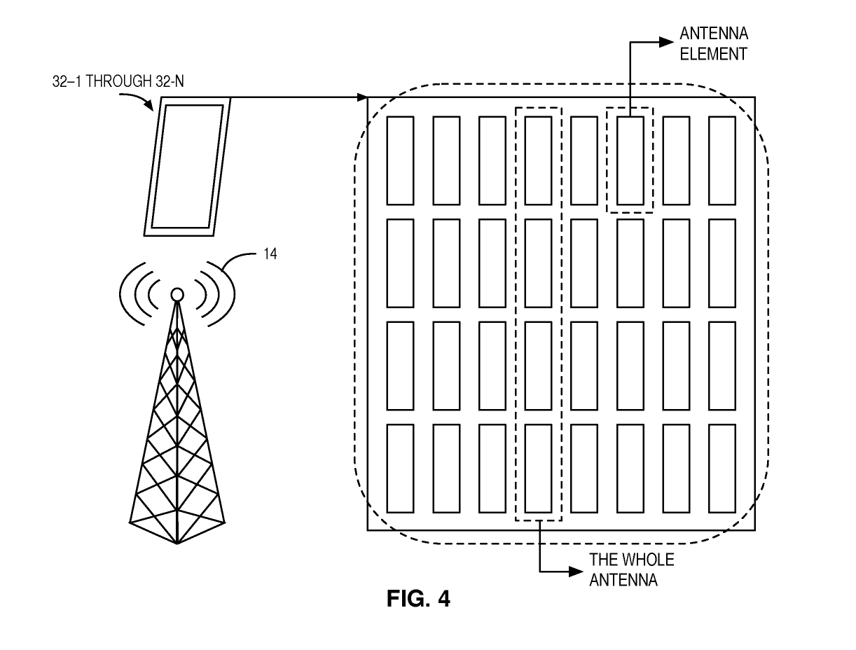

FIG. 5 illustrates a method of operating a node to provide a codebook subset restriction bit map to a wireless device, according to some embodiments of the current disclosure. First, the node 14 (shown here as a eNode B (eNB) 14) determines a codebook restriction for a wireless device 18 (shown here as a UE 18) (step 100). The codebook restriction is a restriction that reduces a full codebook of the wireless device 18 to a reduced codebook. The full codebook includes precoding matrices for several ranks. The node 14 then provides the codebook restriction to the wireless device 18 with an indication of one or more ranks to which the codebook restriction applies. In some embodiments, this enables reduced overhead compared to providing a full codebook subset restriction bit map (step 102). As shown in FIG. 5, the wireless device 18 is then able to transmit channel feedback to the node 14 of the cellular communications network based on the codebook restriction (step 104). This enables reduced signaling overhead from upper layers, improving the throughput of data traffic channels, according to some embodiments. This may also enable reduced RRC signaling message failures and also reduced latency.

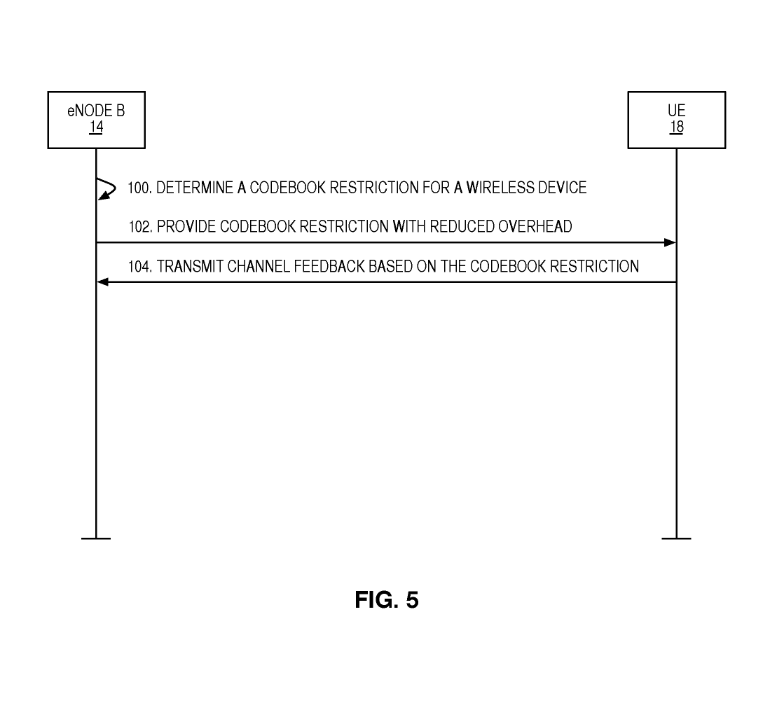

FIG. 6 shows the codebook subset restriction bit map for an Ntx antenna system with maximum rank up to R. The number of codebook elements in a given rank R is denoted by Ncr. Then in the conventional method, during the RRC configuration and re-configuration, the total number of bits sent is equal to:

$${\sum }_{r = 1}^{R} Ncr$$

As an example, consider LTE Release 8, 4Tx MIMO, R=4, N_{c1}=16, N_{c2}=16, N_{c3}=16, and N_{c4}=16. In this scenario, the total number of bits sent during RRC configuration and re-configuration is equal to 64, which is a large number that increases the overhead on PDSCH when the number of antennas is very large as in FD-MIMO.

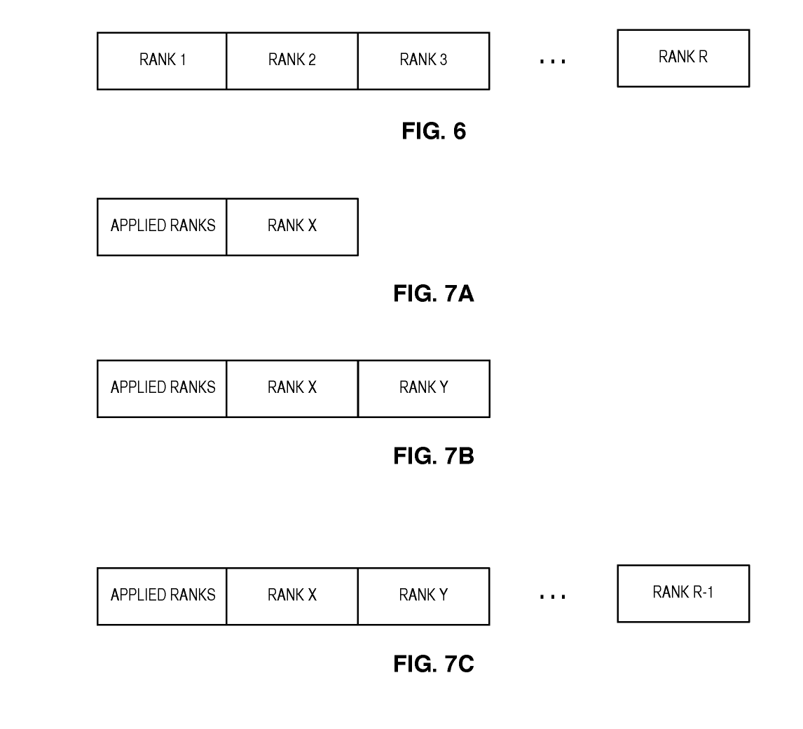

In some embodiments, instead of sending the complete bit map during RRC re-configuration, limited bit maps are signaled corresponding to certain rank(s); i.e., when the bit map is applied to only a subset of rank(s), there is no need to signal the complete bit map. Hence, in some embodiments, the network should send the codebook subset restriction bit maps corresponding to the rank(s) which require changes. Therefore, in some embodiments, during re-configurations, a new field called Applied Ranks is appended to the new codebook subset restriction bit map to indicate those certain ranks on which the new bit map is applied, as shown in FIGS. 7A-7C. Note that the number of bits required to indicate Applied Ranks depends on the number of combinations. The number of combinations follows the binomial series, i.e., _{R}Cᵣ. For example, when only a single rank is considered, then the number of combinations is equal to R, i.e., either 1 or 2 or 3 . . . or R; hence the number of bits equal to Log₂(_{R}Cᵣ). When two ranks are considered, then the number of combinations is equal to _{R}C₂; which is the number of bits equal to Log₂(_{R}C₂), and so on. Note that when all ranks are considered, there is no need to indicate the Applied Ranks, as there is no benefit.

Mathematically, the benefits of the proposed method can be described as follows. For example, in the RRC configuration, the UE is signaled with Σᵣ₌₁^{R} Ncr bits. Then during RRC re-configuration, only the bits belonging to the rank 1 are changed, then the bit map length equal to log 2(R)+Nc1 is signaled. That is, log₂(R) bits indicate the specific rank where the new bit map is applied. Note that log 2(R)+Nc1 is always less than Σᵣ₌₁^{R} Ncr. Therefore, the number of bits saved is equal to log 2(R)−Σᵣ₌₂^{R} Ncr.

For FD-MIMO/MIMO, the codebook subset restriction bit map is set on few ranks during re-configuration in either the horizontal or vertical domain. However, in FD-MIMO for vertical codebook subset restriction, the changes in the vertical domain for higher ranks are very minimal, and consequently, sending the complete bit map during re-configuration increases the signaling overhead. Using the proposed method, the signaling overhead can be minimized by sending the ranks and the corresponding bitmap which requires changes during re-configuration.

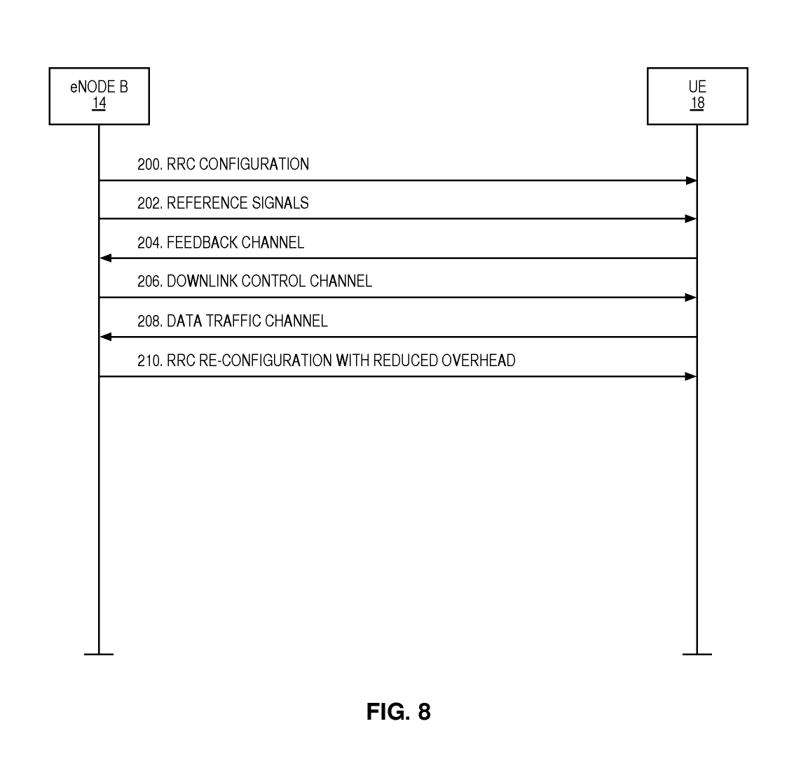

FIGS. 8-10 illustrate potential methods to indicate the proposed bit map to the UE 18. FIG. 8 shows the message sequence chart according to some embodiments. During the RRC configuration, the eNB 14 sends the complete bit map as in the conventional method, i.e., the bit map is equal to Σᵣ₌₂^{R} Ncr (step 200). The node 14 further sends reference signals (step 202) and receives feedback from a feedback channel (step 204). The wireless device 18 receives a downlink control channel (step 206) and transmits on the data traffic channel (step 208).

However, during RRC re-configuration, the node 14 sends an RRC re-configuration with reduced overhead (step 210). For instance, the node 14 indicates the proposed bit map, i.e., Applied Ranks and the bit map correspond to the specific ranks. Note that in this embodiment, this is a higher layer message.

In another embodiment, the network can send the proposed new bit map for codebook subset restriction and the information about the Applied Ranks of codebook subset restriction through physical layer signaling as shown in FIG. 9. In this embodiment, Steps 300-308 correspond to Steps 200-208 discussed above. Instead of sending the updated bit map as an RRC re-configuration, the node 14 sends the proposed bit map on physical layer signaling (step 310). For example, this information can be sent as part of the downlink control channel. Note that this method avoids the delay involved in higher layer signaling (e.g., RRC).

The embodiments discussed in FIGS. 8 and 9 use a full bit map to begin with and only use the reduced overhead version to communicate updates. However, the same principle as explained in the RRC re-configuration can be applied at the network node for RRC signaling. FIG. 10 shows the message sequence chart according to those embodiments. During the RRC set up and configuration (step 400), the node 14 sends the RRC configuration with reduced overhead (step 400). In some embodiments, this is information related to the specific rank(s) and the corresponding bit map for the codebook subset restriction to the UE 18 using RRC setup and configuration. The remaining steps 402-410 correspond to steps 202-210, but could also use the physical layer signaling discussed in relation to step 310.

In some embodiments, once the UE 18 receives and decodes this information, the UE 18 computes the Channel State Information (CSI) from the reference signals and reports the CSI on the precoding codebooks which are set for the specific ranks as indicated by the field Applied Ranks, and for all the other ranks which are not indicated, the UE 18 should use all the precoding codebook elements. By applying this technique, signaling overhead can be reduced at the RRC setup and configuration.

To explain the concept, an example is provided with maximum rank equal to 4. In this scenario, the rank 1, 2, 3, and 4 precoding codebook consists of 16 elements for each rank. Then for RRC re-configuration, Table 2 shows the number of bits saved with the proposed method.

TABLE 2

| | Bit map | | Conven- | | Number |
|---|---|---|---|---|---|
| Allowed | length for | Bit map | tional | Proposed | of bits |
| ranks | allowed ranks | length | method | method | savings |
| 1 | Log2(₄C₁) = 2 | 16 | 64 | 2 + 16 | 46 |
| 2 | Ceil | 16 + 16 | 64 | 3 + 32 | 29 |
| | (Log2(₄C₂)) = 3 | | | | |
| 3 | Log2(₄C₃) = 2 | 16 + | 64 | 2 + 48 | 14 |
| | | 16 + 16 | | | |
| 4 | 0 | 16 + | 64 | 0 + 64 | 0 |
| | | 16 + | | | |
| | | 16 + 16 | | | |

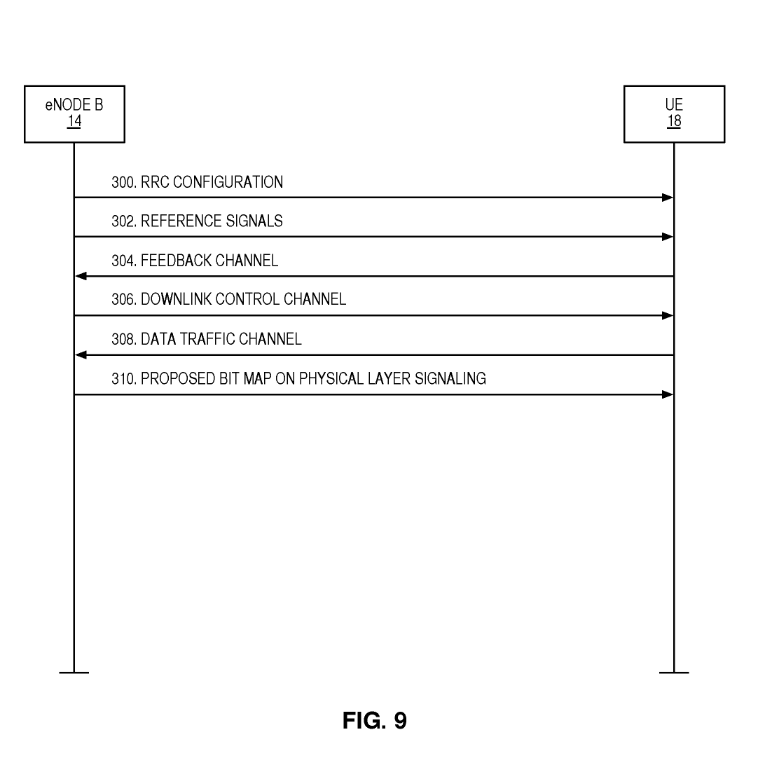

FIG. 11 is a block diagram of the UE 18 according to some embodiments of the present disclosure. As illustrated, the UE 18 includes one or more processors 38 (e.g., one or more Central Processing Units (CPUs), one or more Application Specific Integrated Circuits (ASICs), one or more Field Programmable Gate Arrays (FPGAs), or the like, or any combination thereof), memory 40, and one or more transceivers 42 including one or more transmitters 44 and one or more receivers 46 coupled to one or more antennas 48. In some embodiments, the functionality of the UE 18 described herein is implemented in software, which is stored in the memory 40 and executed by the processor(s) 38.

In some embodiments, a computer program including instructions which, when executed by at least one processor, causes the at least one processor to carry out the functionality of the UE 18 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 40).

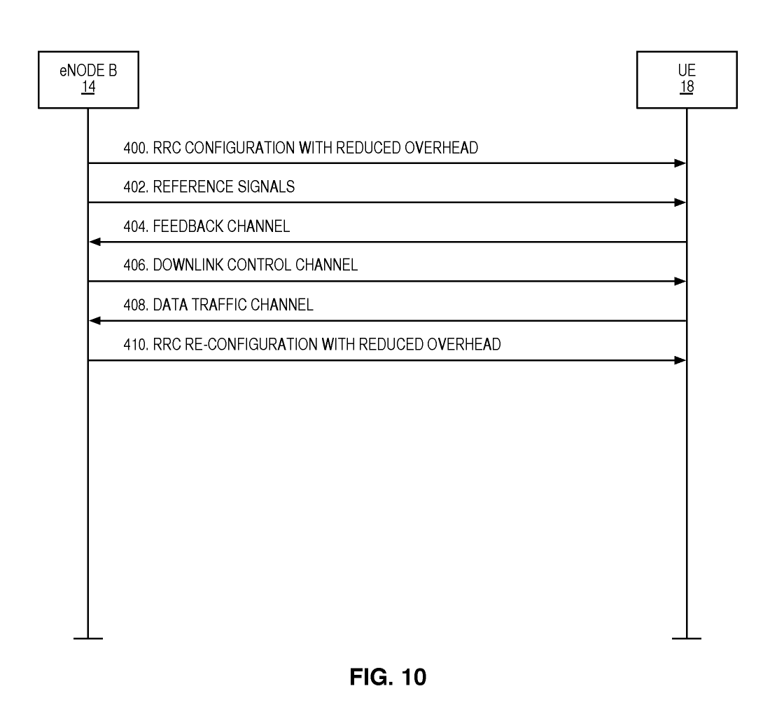

FIG. 12 is a block diagram of the UE 18 according to some other embodiments of the present disclosure. As illustrated, the UE 18 includes one or more modules 50, each of which is implemented in software. The module(s) 50 operate to provide the functionality of the UE 18 according to any of the embodiments described above with respect to FIGS. 5 and 8-10.

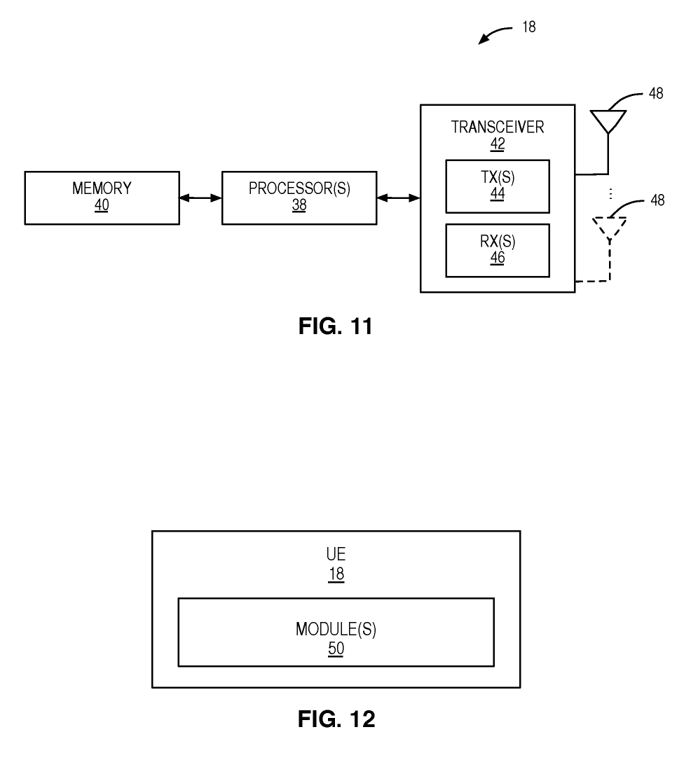

FIG. 13 is a block diagram of the node 14 (e.g., a base station 14, an eNode B 14, etc.) according to some embodiments of the present disclosure. As illustrated, the node 14 includes a baseband unit 28 that includes one or more processors 52 (e.g., one or more CPUs, one or more ASICs, one or more FPGAs, and/or the like, or any combination thereof), memory 54, and a network interface 56 (e.g., a network interface providing a connection to the core network 20 and/or other nodes 14). The node 14 also includes one or more radio units 58 including one or more transmitters 60 and one or more receivers 62 connected to one or more antennas 32-1 through 32-N. In some embodiments, the functionality of the node 14 described herein is implemented in software, which is stored in the memory 54 and executed by the processor(s) 52.

Note that other network nodes may include components similar to those of the node 14 illustrated in FIG. 13.

In some embodiments, a computer program including instructions which, when executed by at least one processor, cause the at least one processor to carry out the functionality of the node 14 (e.g., the base station 14) according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 54).

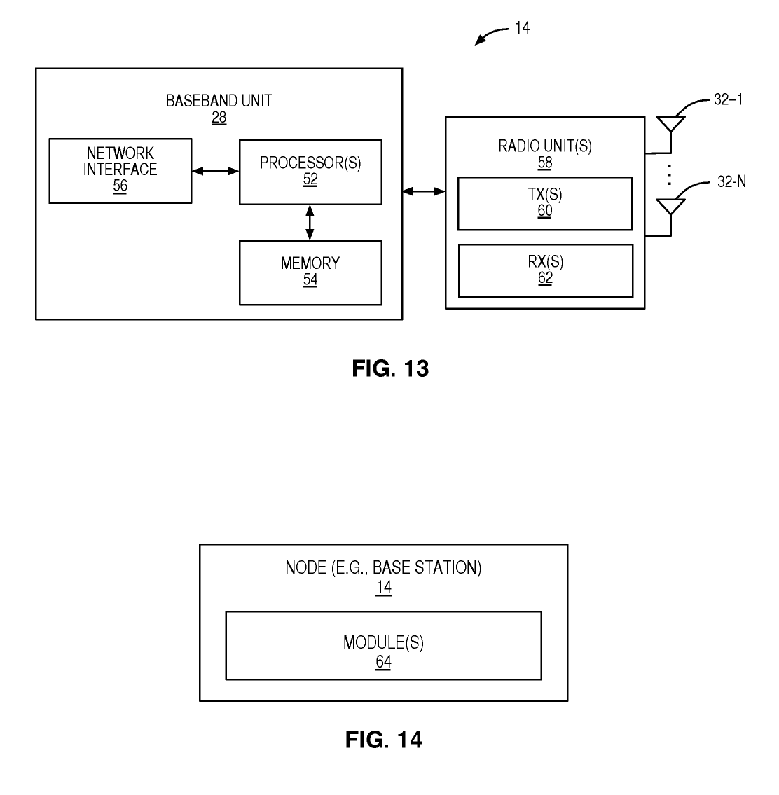

FIG. 14 is a block diagram of a node 14 (e.g., the base station 14) according to some other embodiments of the present disclosure. As illustrated, the node 14 includes one or more modules 64, each of which is implemented in software. The module(s) 64 operate to provide the functionality of the node 14 according to any of the embodiments described above with respect to FIGS. 5 and 8-10.

While various embodiments are described herein, some exemplary embodiments are as follows.

Embodiment 1: A method of operation of a node of a cellular communications network comprising:
providing a codebook restriction to a wireless device with reduced overhead.

Embodiment 2: The method of embodiment 1 wherein the overhead is reduced compared to providing a full codebook subset restriction bit map.

Embodiment 3: The method of embodiment 1 or 2 wherein providing the codebook restriction to the wireless device with reduced overhead comprises providing the codebook restriction to the wireless device by providing an initial RRC configuration with reduced overhead to the wireless device.

Embodiment 4: The method of embodiment 1 or 2 wherein providing the codebook restriction to the wireless device with reduced overhead comprises providing the codebook restriction to the wireless device by providing a RRC re-configuration with reduced overhead to the wireless device.

Embodiment 5: The method of embodiment 1 or 2 wherein providing the codebook restriction to the wireless device with reduced overhead comprises providing the codebook restriction to the wireless device by providing physical layer signaling with reduced overhead to the wireless device.

Embodiment 6: The method of any of the previous embodiments wherein providing the codebook restriction to the wireless device with reduced overhead comprises providing an indication of which ranks the restriction is applicable to the wireless device.

Embodiment 7: The method of any of the previous embodiments wherein the codebook restriction comprises codebook restrictions for a subset of all possible ranks, the subset being less than all possible ranks, and providing the codebook restriction to the wireless device with reduced overhead comprises providing an indication to the wireless device of the subset of all possible ranks to which the codebook restrictions apply.

Embodiment 8: The method of any of the previous embodiments wherein the cellular communications network is an LTE network.

Embodiment 9: The method of embodiment 8 wherein the node is an eNB.

Embodiment 10: A method of operation of a wireless device of a cellular communications network comprising:

receiving a codebook restriction with reduced overhead.

Embodiment 11: The method of embodiment 10 wherein the overhead is reduced compared to receiving a full codebook subset restriction bit map.

Embodiment 12: The method of embodiment 10 or 11 wherein receiving the codebook restriction with reduced overhead comprises receiving the codebook restriction by receiving an initial RRC configuration with reduced overhead.

Embodiment 13: The method of embodiment 10 or 11 wherein receiving the codebook restriction with reduced overhead comprises receiving the codebook restriction by receiving a RRC re-configuration with reduced overhead.

Embodiment 14: The method of embodiment 10 or 11 wherein receiving the codebook restriction with reduced overhead comprises receiving the codebook restriction by receiving physical layer signaling with reduced overhead.

Embodiment 15: The method of any of embodiments 10-14 wherein receiving the codebook restriction with reduced overhead comprises receiving an indication of which ranks the restriction is applicable.

Embodiment 16: The method of any of embodiments 10-14 wherein the codebook restriction comprises codebook restrictions for a subset of all possible ranks, the subset being less than all possible ranks, and receiving the codebook restriction with reduced overhead comprises receiving an indication of the subset of all possible ranks to which the codebook restrictions apply.

Embodiment 17: The method of any of embodiments 10-16 wherein the cellular communications network is an LTE network.

Embodiment 18: A method of operation of a node of a cellular communications network comprising:
providing a codebook restriction to a wireless device with reduced overhead for a two-dimensional antenna system.

Embodiment 19: The method of embodiment 18 wherein providing the codebook restriction comprises providing the codebook restriction for a first direction in the two-dimensional antenna system with reduced overhead.

Embodiment 20: The method of embodiment 19 wherein the first direction is the vertical direction.

Embodiment 21: The method of embodiment 19 wherein the first direction is the horizontal direction.

Embodiment 22: The method of embodiment 18 wherein providing the codebook restriction comprises providing the codebook restriction for a first direction and a second direction in the two-dimensional antenna system with reduced overhead.

Embodiment 23: The method of embodiment 22 wherein the first direction is the horizontal direction and the second direction is the vertical direction.

The following acronyms are used throughout this disclosure.
3GPP 3^{rd} Generation Partnership Project
AAS Active-Array-Antenna Systems
AP Access Point
ASIC Application Specific Integrated Circuit
BS Base Station
BSC Base Station Controller
BTS Base Transceiver Station
CA Carrier Aggregation
CDMA Code Division Multiple AccessCPU
Central Processing Unit
CQI Channel Quality Indicator
CSI Channel State Information
D2D Device-to-Device
DAS Distributed Antenna System
DFT Discrete Fourier Transform
E-UTRA Evolved Universal Terrestrial Radio Access
EDGE Enhanced Data for GSM Evolution
eNB Enhanced or Evolved Node B
FD Full Dimension
FDD Frequency Division Duplex
FPGA Field Programmable Gate Array
FSS Frequency Selective Scheduling
GERAN GSM EDGE Radio Access Network
GSM Global System for Mobile Communication
HARQ Hybrid Automatic Repeat Request
HSDPA High Speed Downlink Packet Access
HSPA High Speed Packet Access
LEE Laptop Embedded Equipment
LME Laptop Mounted Equipment
LTE Long Term Evolution
LTE-A LTE Advanced
M2M Machine-to-Machine
MC Multi-Carrier
MHz Megahertz
MIMO Multiple Input Multiple Output
MSR Multi-Standard Radio
NX New Radio-Access Technology
OFDMA Orthogonal Frequency Division Multiple Access
PCI Precoding Index
PMI Precoding Matrix Indicator
QAM Quadrature Amplitude Modulation
RAT Radio Access Technology
RF Radio Frequency
RI Rank Indicator
RNC Radio Network Controller
RRC Radio Resource Control
RRH Remote Radio Head
RRU Remote Radio Unit
SC-FDMA Single Carrier Frequency Division Multiple Access
SINR Signal to Interference plus Noise Ratio
SM Spatial Multiplexing
TDD Time Division Duplex
UE User Equipment
UMTS Universal Mobile Telecommunications Service
USB Universal Serial Bus
UTRA Universal Terrestrial Radio Access
WiMax Worldwide Interoperability for Microwave Access
WLAN Wireless Local Area Network

Those skilled in the art will recognize improvements and modifications to the embodiments of the present disclosure. All such improvements and modifications are considered within the scope of the concepts disclosed herein and the claims that follow.

1. A method of operation of a node of a cellular communications network comprising:
determining a codebook restriction for a wireless device, the codebook restriction being a restriction that reduces a full codebook of the wireless device to a reduced codebook, the full codebook comprising precoding matrices for a plurality of ranks; and
providing the codebook restriction to the wireless device with an indication of one or more ranks of the plurality of ranks to which the codebook restriction applies.

2. The method of claim 1 wherein providing the codebook restriction to the wireless device comprises providing the codebook restriction to the wireless device by providing, to the wireless device, an initial Radio Resource Control, RRC, configuration, or
comprises providing the codebook restriction to the wireless device by providing, to the wireless device, a Radio Resource Control, RRC, re-configuration, or
comprises providing, to the wireless device, the codebook restriction to the wireless device by using physical layer signaling, or
comprises providing, to the wireless device, a field called Applied Ranks comprising the indication of the one or more ranks of the plurality of ranks to which the codebook restriction applies.

3-5. (canceled)

6. The method of claim 1 wherein the codebook restriction comprises codebook restrictions for a subset of all possible ranks, the subset having fewer than all possible ranks, and providing the codebook restriction to the wireless device comprises providing, to the wireless device, an indication of the subset of all possible ranks to which the codebook restrictions apply.

7. The method of claim 1 wherein the codebook restriction is for a two-dimensional antenna system.

8. The method of claim 7 wherein providing the codebook restriction comprises providing the codebook restriction for a first direction in the two-dimensional antenna system.

9. The method of claim 8 wherein the first direction is a vertical or a horizontal direction.

10. (canceled)

11. The method of claim 7 wherein providing the codebook restriction comprises providing the codebook restriction for a first direction and a second direction in the two-dimensional antenna system.

12. The method of claim 11 wherein the first direction is a horizontal direction and the second direction is a vertical direction.

13-15. (canceled)

16. A node comprising:
circuitry comprising one or more processors and a memory containing instructions whereby the node is configured to:
determine a codebook restriction for a wireless device, the codebook restriction being a restriction that reduces a full codebook of the wireless device to a reduced codebook, the full codebook comprising precoding matrices for a plurality of ranks; and
provide the codebook restriction to the wireless device an indication of one or more ranks of the plurality of ranks to which the codebook restriction applies.

17-30. (canceled)

31. A method of operation of a wireless device of a cellular communications network comprising:
receiving a codebook restriction with an indication of one or more ranks of a plurality of ranks to which the codebook restriction applies, the codebook restriction being a restriction that reduces a full codebook of the wireless device to a reduced codebook, the full codebook comprising precoding matrices for the plurality of ranks; and
transmitting channel feedback to a node of the cellular communications network based on the codebook restriction.

32. The method of claim 31 wherein receiving the codebook restriction comprises receiving the codebook restriction by receiving an initial Radio Resource Control, RRC, configuration, or
comprises receiving the codebook restriction by receiving physical layer signaling, or
comprises receiving the codebook restriction by receiving an RRC re-configuration, or
comprises receiving a field called Applied Ranks comprising the indication of the one or more ranks of the plurality of ranks to which the codebook restriction applies.

33-35. (canceled)

36. The method of claim 31 wherein the codebook restriction comprises codebook restrictions for a subset of all possible ranks, the subset having fewer than all possible ranks, and receiving the codebook restriction comprises receiving an indication of the subset of all possible ranks to which the codebook restrictions apply.

37. The method of claim 31 wherein the codebook restriction is for a two-dimensional antenna system.

38. The method of claim 37 wherein receiving the codebook restriction comprises receiving the codebook restriction for a first direction in the two-dimensional antenna system.

39. The method of claim 38 wherein the first direction is a vertical or a horizontal direction.

40. (canceled)

41. The method of claim 37 wherein receiving the codebook restriction comprises receiving the codebook restriction for a first direction and a second direction in the two-dimensional antenna system.

42. The method of claim 41 wherein the first direction is a horizontal direction and the second direction is a vertical direction.

43-45. (canceled)

46. A User Equipment, UE, comprising:
circuitry comprising one or more processors and a memory containing instructions whereby the UE is configured to:
receive a codebook restriction with an indication of one or more ranks of a plurality of ranks to which the codebook restriction applies, the codebook restriction being a restriction that reduces a full codebook of the wireless device to a reduced codebook, the full codebook comprising precoding matrices for the plurality of ranks; and
transmit channel feedback to a node of a cellular communications network based on the codebook restriction.

47-60. (canceled)

61. A User Equipment, UE, adapted to:
receive a codebook restriction with an indication of one or more ranks of a plurality of ranks to which the codebook restriction applies, the codebook restriction being a restriction that reduces a full codebook of the wireless device to a reduced codebook, the full codebook comprising precoding matrices for the plurality of ranks; and
transmit channel feedback to a node of a cellular communications network based on the codebook restriction.

62-65. (canceled)

66. A node adapted to:
determine a codebook restriction for a wireless device, the codebook restriction being a restriction that reduces a full codebook of the wireless device to a reduced codebook, the full codebook comprising precoding matrices for a plurality of ranks; and
provide the codebook restriction to the wireless device with an indication of one or more ranks of the plurality of ranks to which the codebook restriction applies.

67-70. (canceled)
